(19) United States
(12) Patent Application Publication
(10) Pub. No.: US 2026/0164099 A1
(43) Pub. Date: Jun. 11, 2026

(54) Identifying Advertising Pod Start and End Times Using Watermarks

(71) Applicant: The Nielsen Company (US), LLC, New York, NY (US)

(72) Inventors: Stanley Wellington Woodruff, Palm Harbor, FL (US); John T. LiVoti, Clearwater, FL (US)

(21) Appl. No.: 19/395,350

(22) Filed: Nov. 20, 2025

Related U.S. Application Data
(60) Provisional application No. 63/729,546, filed on Dec. 9, 2024.

(51) Int. Cl. H04N 21/8358; H04N 21/234; H04N 21/81

(52) U.S. Cl. CPC H04N 21/8358; H04N 21/23418; H04N 21/812

(57) ABSTRACT

In one example, a method is described. The method includes obtaining a video stream of media content. The media content includes an advertising portion and a program portion. The advertising portion includes a plurality of advertising pods interleaved with the program portion. The method further includes detecting watermarks embedded in the video stream and determining, using the detected watermarks, the plurality of advertising pods in the video stream. The method further includes adjusting, using reference data from a database, a length of at least one advertising pod of the plurality of advertising pods in the video stream; and separating, after the adjusting, the program portion from the advertising pods in the video stream.

### CROSS-REFERENCE TO RELATED APPLICATION(S)

This disclosure claims the benefit of U.S. Provisional Patent Application No. 63/729,546, filed Dec. 9, 2024, which is hereby incorporated herein by reference in its entirety. Priority to U.S. Provisional Patent Application No. 63/729,546 is hereby claimed.

### BACKGROUND

The present disclosure relates in general to advertisement (“ad”) pod detection, and in particular, to determining start and end times of an advertisement pod using watermarks.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect a method is described. The method includes obtaining a video stream of media content. The media content includes an advertising portion and a program portion. The advertising portion includes a plurality of advertising pods interleaved with the program portion. The method further includes detecting watermarks embedded in the video stream; determining, using the detected watermarks, the plurality of advertising pods in the video stream; adjusting, using reference data from a database, a length of at least one advertising pod of the plurality of advertising pods in the video stream; and separating, after the adjusting, the program portion from the advertising pods in the video stream.

In some aspects, the method also includes outputting the adjusted length of the at least one advertising pod. In one or more aspects, the reference data from the database includes historical reference data related to lengths of advertising pod. In various instances, the method further includes identifying a network or a streaming service associated with the video stream, and the reference data corresponds to historical reference data related to lengths of advertising pods for the network or the streaming service. In some aspects, the method includes storing, in another database, the separated advertising pods. In one or more aspects, the method includes the adjusting, using the reference data from the database, the length of the at least one advertising pod includes adjusting at least one of a start time or an end time of the at least one advertising pod and outputting, after the adjusting, start and end times of each advertising pod of the advertising pods. The method includes, in one or more aspects, storing the separated advertising pods.

In another aspect, a non-transitory computer-readable storage medium, having stored thereon program instructions that, upon execution by a processor, cause performance of operations is described. The operations include obtaining a video stream of media content with a plurality of watermarks embedded in the video stream. The advertising portion includes a plurality of advertising pods interleaved with the program portion. The media content includes an advertising portion and a program portion. The operations also include determining, using the watermarks, the plurality of advertising pods in the video stream; adjusting, using reference data from a database, at least one of a start time or an end time of an advertising pod of the plurality of advertising pods in the video stream; and separating, after the adjusting, the program portion from the advertising pods in the video stream.

In some aspects, the operations also include detecting the watermarks embedded in the video stream. In one or more aspects, the reference data from the database includes historical reference data related to start and end times of advertising pods. The operations, in various aspects, include identifying a network or a streaming service associated with the video stream, and the reference data corresponds to historical reference data related to start and end times of advertising pods for the network or the streaming service. The operations also include, in one or more aspects, identifying content associated with the program portion of the video stream, and the reference data corresponds to historical reference data related to start and end times of advertising pods for the content. In some aspects, the operations include storing, in another database, the separated advertising pods and identifying, from the separated advertising pods, content of at least one advertisement.

In another aspect, a computing system is described. The computing system includes a processor and a non-transitory computer-readable storage medium, having stored thereon program instructions that, upon execution by the processor, cause performance of operations. The operations include obtaining a video stream of media content. The media content includes an advertising portion and a program portion, and the advertising portion includes a plurality of advertising pods interleaved with the program portion. The operations also include detecting watermarks embedded in the video stream; determining, using the detected watermarks, the plurality of advertising pods in the video stream; adjusting, using reference data from a database, at least one of a start time or an end time of an advertising pod of the plurality of advertising pods in the video stream; and separating, after the adjusting, the program portion from the advertising pods in the video stream.

In some aspects, the operations further include identifying a network or a streaming service associated with the video stream, and the reference data corresponds to historical reference data related to start and end times of advertising pods for the network or the streaming service. In one or more aspects, the operations further include identifying content associated with the program portion of the video stream, and the reference data corresponds to historical reference data related to start and end times of advertising pods for the content. In several aspects, the operations include storing, in another database, the separated advertising pods. In one or more aspects, the operations include identifying, from the separated advertising pods, content of at least one advertisement.

### BRIEF DESCRIPTION OF THE DRAWINGS

FIG. 1 is a simplified block diagram of an example computing device in accordance with one or more aspects.

FIG. 2 is a diagrammatic illustration of a data flow of the example computing device in accordance with one or more aspects.

FIG. 3 is a diagrammatic illustration of a watermark analysis module of the diagrammatic illustration of FIG. 2 in accordance with one or more aspects.

FIG. 4 is a flow chart of an example method in accordance with one or more aspects.

FIG. 5A is a diagrammatic illustration of a video stream in accordance with one or more aspects.

FIG. 5B is a diagrammatic illustration of a historical reference data in accordance with one or more aspects.

FIG. 5C is a diagrammatic illustration of a comparison of the video stream of FIG. 5A and the historical reference data of FIG. 5B in accordance with one or more aspects.

FIG. 5D is a diagrammatic illustration of an adjusted video stream in accordance with one or more aspects.

FIG. 5E is a diagrammatic illustration of a program portion and an advertising portion in accordance with one or more aspects.

FIG. 6 is another flow chart of an example method in accordance with one or more aspects.

### DETAILED DESCRIPTION

### I. Overview

Media content can contain a program portion and an advertisement portion. For example, television show A airs Friday at 7:30 pm Eastern time for thirty minutes and the total program portion is 24 minutes in length and the total advertisement portion is 6 minutes in length. The advertisement portion can be broken into a set of commercial breaks or advertisement (“ad”) pods that interrupt the program portion intermittently. Each such commercial break can have a varying length and contain a varying number of individual advertisements.

The placement of advertisements within the program portion is influenced by many factors (such as advertising inventory requirements, total program content length, scripting of the program content, network requirements, and the like) and can be unpredictable in advance (such as advertising breaks timed to coincide with time outs during live sports). While program guide information can be used to identify and/or validate start and end times of the media content, it can be difficult to identify and/or validate start and end times of ad pods within the advertisement portion of the media content.

One or more examples are described herein for advantageously determining when the ad portion of the media content (“ad pods”) occurs in the media content. For example, watermarks can be encoded in the program portion of the media content at one or more expected intervals (such as 4.8 seconds and 6 seconds). A computing system can use these watermarks to identify the content of the program portion of the media content. The ad pods, in some instances, do not have any watermarks encoded. The breaks in the media content that do not have decoded watermarks can be identified as ad pods.

In some instances, the identified ad pods are accurate and do not require further refinement. However, in other instances, the program portion continues after and/or before a watermark is identified, and the actual ad pod is shorter than the identified ad pod. The identified ad pod can be further refined to adjust the start and end time of the respective ad pods, using historical information, which updates the identified ad pods to match the actual ad pods. Historical information can include program specific reference data. For instance, program specific reference data may indicate that the television show “Abbott Elementary” tends to run 24 minutes in length for the program portion and have four ad pods, each running one minute and thirty seconds in length. Historical information can also include network and/or streaming application information such as HULU® runs a six second ad pod, followed by a two-minute ad pod, followed by a thirty second ad pod, and followed by a fifteen second ad pod for television shows that have a program portion under thirty minutes. A computing system can use the historical information to refine the start and/or end times of one or more ad pod(s) in the advertising portion of the media content.

Several examples are described herein for advantageously determining a start and end time of an ad pod. For example, commercial watermarks can be encoded in the advertising portion of the media content at one or more expected intervals (such as every three seconds, for each advertisement in an ad pod, and the like). A computing system can use these commercial watermarks to distinguish the ad pod from the program portion. The portions in the media content that have decoded commercial watermarks can be identified as ad pods.

In some instances, the identified ad pods are accurate and do not require further refinement. However, in other instances, the advertising portion continues after and/or before a commercial watermark is identified, and the actual ad pod is longer than the identified ad pod. The identified ad pod can be further refined to adjust the start and end time of the respective ad pods, using historical information, which updates the identified ad pods to match the actual ad pods. Historical information can include program specific reference data such as the television show “Chicago P.D” on NBC® tends to run forty-four minutes in length for the program portion and have eight ad pods, each running two minutes in length. Historical information can also include network and/or streaming application information such as Amazon Prime Video® runs a fifteen second ad pod, followed by thirty second ad pod, followed by a thirty second ad pod, and followed by a fifteen second ad pod for television shows that have a program portion under thirty minutes. Historical information can also include advertising information such as the first ad in an ad pod is identified as a Coca-Cola® advertisement using a decoded commercial watermark, and Coca-Cola® tends to buy 30 second ads not 45 second ads. The historical information refines the start and/or end times of one or more ad pod(s) in the advertising portion of the media content.

Several examples are described herein for advantageously determining a start and end time of an ad pod using watermarks and historical information. By identifying the ad pods from the program portion, the ad pods can be separated from the program portion. The video and/or audio that corresponds to the ad pods can be separated from the video and/or audio that corresponds to the program portion. The ad pods can then be sent to a database that stores ad pods or data about ad pods. A computing system can then analyze the ad pods to determine the makeup of each ad in the ad pod.

For example, a first ad pod can be analyzed to determine its makeup. The makeup of the first ad pod can be identified as a fifteen second ad, a thirty second ad, a forty-five second ad, a two-minute ad, and another fifteen second ad, respectively. The ads of the first ad pod can then be compared to one or more references in one or more reference databases to identify the ads in the first ad pod. By separating the ad pods from the program portion, computation resources are reduced, as less processing power is required to analyze the video and/or audio corresponding to the ad pods and less storage space is needed since the program portion is removed. Additionally, the ads of the first ad pod can be compared to references and/or reference databases that correspond to the length of the determined ad (e.g., a fifteen-second ad might only be compared to reference advertisements with a length of fifteen seconds), which also reduces the computational resources required for processing and identifying the ads. When the ads in the ad pod are identified, the ads can be credited. The program portion can be sent to a database that stores program portions or data about program portions, and identified separately from the ad pods, which reduces the processing power required to analyze the program portion. The program portion can then be credited.

The operations and systems, described herein, provide techniques for improving audience measurement technology by reducing the time and resources (e.g., computing power, computing time, and cost) to credit media—by determining the start and end times of ad pods, the advertising portion of media content can be separated from the program portion of the media content and analyzed with less time and resources.

### II. System Architecture

Any one or more of the components described herein can take the form of a computing device, or a computing system that includes one or more computing devices.

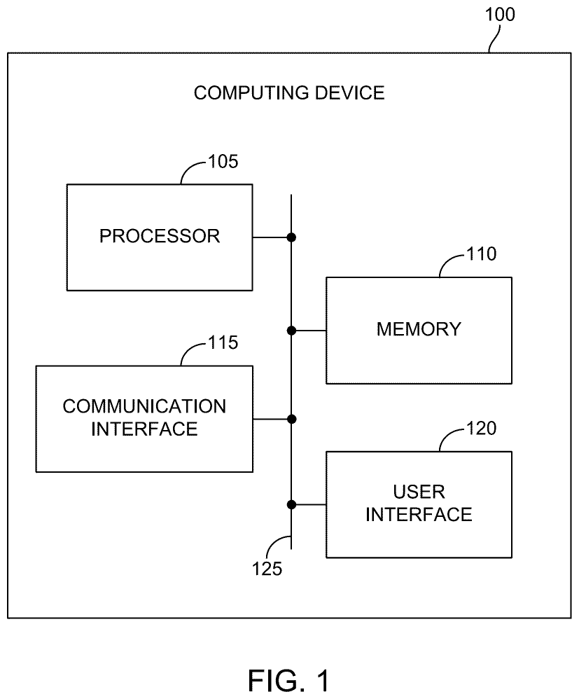

FIG. 1 is a simplified block diagram of an example computing device 100. The computing device 100 can be configured to perform one or more operations, such as the operations described in this disclosure. As shown, the computing device 100 can include various components, such as a processor 105, memory 110, a communication interface 115, and/or a user interface 120. These components can be connected to each other (or to another device, system, or other entity) via a connection mechanism 125.

The processor 105 can include one or more general-purpose processors and/or one or more special-purpose processors.

Memory 110 can include one or more volatile, non-volatile, removable, and/or non-removable storage components, such as magnetic, optical, or flash storage, and/or can be integrated in whole or in part with the processor 105. Further, memory 110 can take the form of a non-transitory computer-readable storage medium, having stored thereon computer-readable program instructions (e.g., compiled or non-compiled program logic and/or machine code) that, upon execution by the processor 105, cause the computing device 100 to perform one or more operations, such as those described in this disclosure. The program instructions can define and/or be part of a discrete software application. In some examples, the computing device 100 can execute the program instructions in response to receiving an input (e.g., via the communication interface 115 and/or the user interface 120). Memory 110 can also store other types of data, such as those types described in this disclosure. In some examples, memory 110 can be implemented using a single physical device, while in other examples, memory 110 can be implemented using two or more physical devices.

The communication interface 115 can include one or more wired interfaces (e.g., an Ethernet interface) or one or more wireless interfaces (e.g., a cellular interface, Wi-Fi interface, or Bluetooth® interface). Such interfaces allow the computing device 100 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission.

The user interface 120 can facilitate interaction between computing device 100 and a user of computing device 100, if applicable. As such, the user interface 120 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 120 can include hardware and/or software components that facilitate interaction between the computing device 100 and the user of the computing device 100.

The connection mechanism 125 can be a cable, system bus, computer network connection, or other form of a wired or wireless connection between components of the computing device 100.

One or more of the components of the computing device 100 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 100 can be combined into a single component, and the function described herein for a single component can be subdivided among multiple components.

In some instances, the computing device 100 can be associated with a collections facility of an audience measurement entity (“AME”). The computing device 100 can be a plurality of computing devices such as servers operable coupled to a plurality of databases such as memory 110.

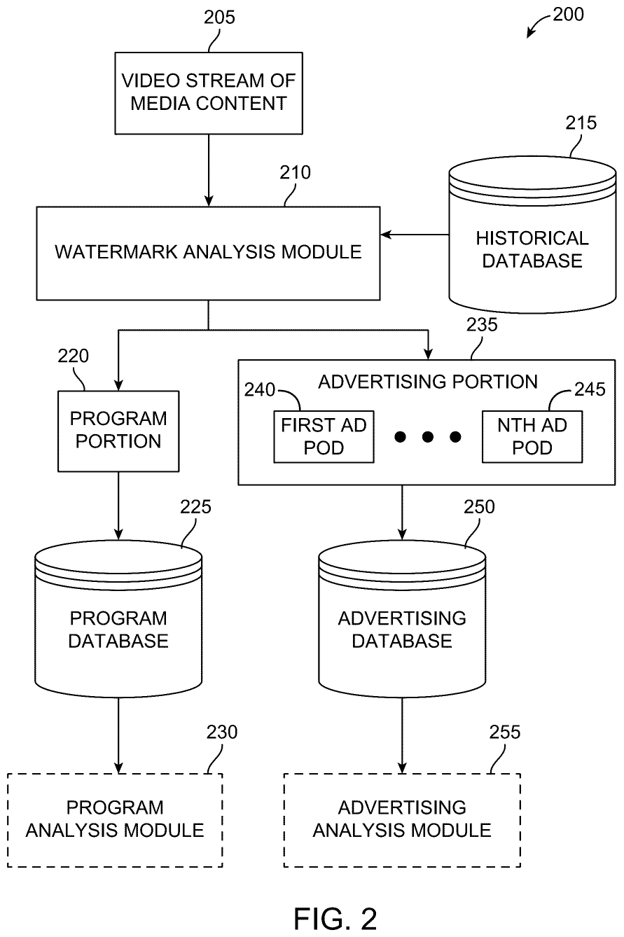

FIG. 2 is a simplified block diagram of a data flow 200 of computing device 100, in accordance with one or more aspects. As shown in FIG. 2, a video stream of media content 205 is sent to a watermark analysis module 210 for processing, as described herein. The video stream of media content 205 includes a program portion interleaved with an advertising portion (for example, a television program interleaved with various commercial breaks). The video stream of media content 205 includes one or more embedded watermarks. A watermark is any identification information that may be inserted or embedded in audio or video of media (e.g., program or an advertisement) for the purpose of identifying media. The watermark can include an audio watermark or a video watermark. The watermark analysis module 210 is in communication with a historical database 215. The watermark analysis module 210 outputs the program portion 220 of the media content, which is then stored in a program database 225.

The program database 225 is in communication with a program analysis module 230. The program portion 220 can be sent from the program database 225 to a program analysis module 230. The program analysis module 230 is configured to identify the program associated with the program portion 220 and/or to credit the program associated with the program portion 220, as having been watched by a user or a plurality of users. The watermark analysis module 210 outputs an advertising portion 235 from the video stream of media content 205. The advertising portion 235 corresponds to the advertisements within the video stream of media content. The advertising portion 235 includes one or more ad pods such as a first ad pod 240 to an nth ad pod 245. The first ad pod 240 can correspond to a first commercial break within the video stream of the media content 205, while the nth ad pod 245 can correspond to a last commercial break within the video stream of media content 205. The advertising database 250 is in communication with the watermark analysis module 210.

The advertising database 250 is configured to store the advertising portion 235. The advertising database 250 is in communication with an advertising analysis module 255. The advertising analysis module 255 is configured to identify start and end times of individual ads within an ad pod (e.g., first ad pod 240), identify individual ads within an ad pod, and/or credit the individual ads as having been presented and watched by one or more users.

In some aspects, the watermark can be imperceptible to humans. A television or radio network can encode an audio watermark into media, including but not limited to: television broadcasts, radio broadcasts, advertisements, downloaded media, streaming media, and on-demand media. Watermarking techniques identify a medium by embedding a code (referred to herein as “a watermark”) into an audio component or a video component having signal characteristics to conceal the watermark. There are multiple types of watermarks that use different signal characteristics to conceal the watermark and the underlying media identification information. Based on the signal characteristics, the different types of watermarks are embedded in the media at a different rate (such as, but not limited to, every 1.6 seconds, every 4.8 seconds, and every 6 seconds). For example, for a television show, based on the watermark type used, a watermark can be embedded in the television show every 3.2 seconds except for the portions that are ad pods. The watermark can be an audio watermark or a video watermark that includes a source identifier (e.g., a station identifier) as well as a date and/or time. The source identifier can include a station identifier, a client identifier (e.g., media content producer identifiers, media content distributor identifiers, etc.), and/or media identifiers (e.g., content identifiers, media identifiers with a time stamp, etc.). The watermark, in some instances, is a multilayer watermark. For example, a first encoding layer of the multilayered watermark can include a first bit sequence corresponding to a client identifier and a second bit sequence pertaining to a content identifier.

In some aspects, the video stream of media content 205 includes watermarks to identify the media content. Additionally, or alternatively, the video stream of media content 205 can include watermarks to identify the commercials (i.e., commercial watermarks). The video stream of media content 205 can include a television show, a movie, a plurality of television shows, a plurality of movies, a video game, combination of television shows and movies, and the like. The video stream of media content 205 can instead be an audio stream of media content such as a podcast.

In some aspects, the watermark analysis module 210 includes a watermark decoder that is configured to extract and decode the watermarks embedded in the video stream of media content 205. In other aspects, the watermark decoder is a separate module or function from the watermark analysis module 210, and the watermark analysis module 210 instead receives the decoded watermarks from the separate module or function. The decoded watermarks can be compared to a reference watermark and/or other metadata mapped to media identification information to identify the watermarked media content.

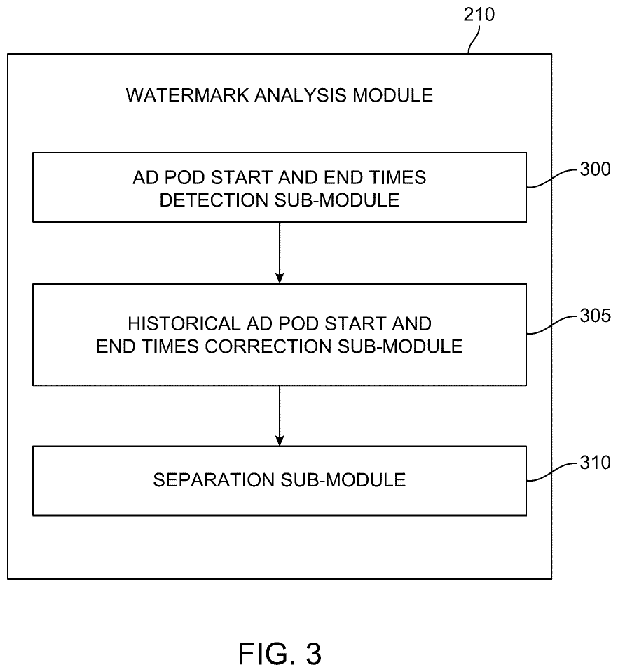

Turning to FIG. 3, with continuing reference to FIGS. 1 and 2, the watermark analysis module 210 is described in further detail, in accordance with one or more aspects. The watermark analysis module 210 includes an ad pod start and end time detection sub-module 300, a historical ad pod start and end times correction sub-module 305, and a separation sub-module 310. The ad pod start and end times detection sub-module 300 is in communication with the historical ad pod start and end time correction sub-module 305. The historical ad pod start and end times correction sub-module is in communication with the separation sub-module 310.

The ad pod start and end times detection sub-module 300 is configured to determine start and end times of one or more ad pods within the video stream of media content 205. The ad pod start and end times detection sub-module 300 outputs start and end times of one or more ad pods within the video stream of media content 205 to the historical ad pod start and end times correction sub-module 305.

The historical ad pod start and end times correction sub-module 305 is in communication with the historical database 215. The historical ad pod start and end times correction sub-module 305 is configured to update the start and end times of the one or more ad pods sent from the ad pod start and end times detection sub-module 300 using historical reference data from the historical database 215. The updated start and end times of the one or more ad pods is output to the separation sub-module 310.

The separation sub-module 310 is configured to separate the program portion 220 from the advertising portion 235 (which can include the first ad pod 240 to the nth ad pod 245), using the updated start and end times of the one or more ad pods. The separation sub-module 310 of the watermark analysis module 210 is in communication with the program database 225 and the advertising database 250. The separation sub-module 310 is configured to send the program portion 220 to the program database for storage and the advertising portion 235 to the advertising database 250 for storage.

In several aspects, the ad pod start and end times detection sub-module 300 is configured to use detected, extracted, and/or decoded watermarks within the video stream of media content 205 to identify start and end times of the one or more ad pods. The ad pod start and end times detection sub-module 300 can be configured to detect and/or decode watermarks within the video stream of media content 205

In some aspects, the ad pod start and end time detection sub-module is in communication with the separation sub-module 310, bypassing the historical ad pod start and end time correction sub-module 305.

In one or more aspects, the historical ad pod start and end times correction sub-module 305 is configured to verify that the start and end times of the one or more ad pods matches with historical reference data from the historical database 215, and if a match is determined, then the start and end times of the one or more ad pods remain unchanged.

In some aspects, the separation sub-module 310 splices the video stream of media content to form the program portion 220 and/or to form the advertising portion 235. The separation sub-module 310 can be a video splicer or the like. For example, the separation sub-module 310 can splice several different program portions together, forming the program portion 220. The program portion 220 can represent, for example, a full television show without the advertisements. The separation sub-module 310 can separate each ad pod within the advertising portion 235 from one another, and the advertising database 250 can store each ad pod separately. In other aspects, the separation sub-module 310 splices the advertising portion 235 (all ad pods from the first ad pod 240 to the nth ad pod 245 together) to form the advertising portion 235, and the advertising portion 235 is stored together in the advertising database 250.

Returning to FIG. 2, with continuing reference to FIG. 1, in some aspects, the historical database 215 is one or more historical reference databases. Each historical reference database of the plurality of historical reference databases can be separated by network, streaming service, program type, and the like. For example, one historical reference database can be for ABC® and contain historical reference information about this network such as programs, program length, ad pod start and end times used by the network, ad pod length, number of ad pods, when the ad pods are inserted within a program, number of ads within an ad pod, and the like. The historical database 215 can be trained on historical reference data for each network to determine start and end times of ad pods for the network. The historical database 215 includes specific ad pod information for a program within the network database. For example, the historical database 215 can have been trained using the last ten seasons of “Grey's Anatomy®” to generate the likely start and end times of each ad pod of the new season of “Grey's Anatomy®”. The historical database 215 can be trained using a machine learning model to generate start and end times of ad pods within media content, generate a number of ad pods, and/or determine when the ad pods are to occur within the media content.

In some aspects, the program portion 220 corresponds to the program portion of the media content such as a television show, podcast, movie, and the like. The program portion 220 can be spliced together by the separation sub-module 310, having removed the advertising portion 235.

In one or more aspects, the program database 225 is one or more databases configured to store the program portion 220. For example, a first program database can store television shows that run twenty-two minutes in length, a second program database can store television shows that run forty-four minutes in length, a third program database can store programs over an hour in length, and the like. The program portion 220 can be stored as a video file. Information about the program portion 220 such as watermarks associated with the program portion 220, metadata, and the like can also be stored in the program database 225. The program database 225 can be separate and distinct from the advertising database 250.

In various aspects, the program database 225 is optional. Instead of being stored, the program portion 220 is deleted, not stored, and/or otherwise removed from the advertising portion 235.

In some aspects, the program analysis module 230 is optional. The program analysis module 230 can call and/or receive program portion 220 from the program database 225. The program analysis module 230 is configured to identify the program portion 220. The program analysis module 230 can be configured to compare the program portion 220 to a set of reference information (such as reference signatures or watermark information) to identify the program portion 220. The program analysis module 230 can be configured to determine a total length (e.g., twenty-four minutes, an hour and thirty minutes, etc.) for the program portion 220. For example, the program analysis module 230 can compare the program portion 220 from the program database 225 to references in a reference database that have a similar total length and determine that the program portion is the television show “The Voice.” The program analysis module 230 is configured to credit “The Voice” as having been watched by one or more users. The program analysis module 230 saves computational resources and time by comparing the program portion 220 to reference data having a similar total length, rather than comparing the program portion 220 to all reference data until a match is found.

In some instances, the advertising portion 235 is only the first ad pod 240. In other instances, the advertising portion 235 includes a plurality of ad pods such as the first ad pod 240 to the nth ad pod 245. The advertising portion 235 can include ad pod(s) that have a single advertisement or a plurality of advertisements. The first ad pod 240 can differ from other ad pods in the advertising portion 235 in total length, in number of ads, and the length of ads within the ad pod. For example, the first ad pod 240 can include one advertisement in the ad first ad pod 240, the one advertisement that runs for six seconds, and the first ad pod 240 can run for the total of six seconds, whereas a second ad pod can include six advertisements in the second ad pod, the six advertisements each running for fifteen seconds, and the second ad pod can run for a total of ninety seconds. The advertising portion 235 can be a series of discrete ad pods that are stored separately in the advertising database 250. In other instances, the ad pods in the advertising portion 235 are combined and stored in the advertising database 250.

In some instances, the advertising database 250 can store each ad pod individually, each ad individually, or the entire advertising portion 235.

In one or more aspects, the advertising analysis module 255 is optional.

In some aspects, the advertising analysis module 255 is configured to call and/or receive advertisements, ad pods, and/or the advertising portion 235 from the advertising database 250. The advertising analysis module 255 is configured to determine lengths of ads within an ad pod and/or to identify the ad content and/or campaign of the ads within the ad pod. For example, the advertising analysis module can determine that the ad pod has two one-minute ads, each ad can be compared to references (signature references and/or watermark information) stored in a reference database, and identified when a match occurs—the first ad is a Mountain Dew® ad and the second ad is a Ford® ad. The one-minute ads can be compared to references in the reference database that are also one minute in length, thereby reducing the processing power and time required to identify ads. The advertising analysis module 255 can be configured to credit ads (such as the Mountain Dew® ad) as having been watched by the user.

In operation, the watermark analysis module 210 ingests the video stream of media content 205. The watermark analysis module 210 identifies the watermarks embedded in the video steam of the media content 205. The watermarks can be used to identify the program portion from the advertising portion of the media content (also referred to herein as “ad pods”). The watermark analysis module 210 uses the ad pod start and end times detection sub-module 300 to determine a start time and an end time of each ad pod within the video stream of media content 205. The watermark analysis module 210 is in communication with the historical database 215. Historical reference information from the historical database 215 is used by the historical ad pod start and end times correction sub-module 305 of the watermark analysis module 210 to adjust the start and end times of one or more of the ad pods. The historical reference information can be based on the program, total length of the media content, broadcast network, streaming service, or the like.

In some aspects, media content the program portion 220 is identified by a decoded watermark prior to the watermark analysis module 210 or using the watermark analysis module 210. For example, if the video stream 205 has multiple watermarks that are decoded to reveal the TV show “Dancing with the Stars®” then that media identification information can be fed into the historical database 215. The historical database 215 can then filter historical data for ABC® and/or historical data for “Dancing with the Stars®”, which can include historical ad pod start and end times, and/or historical ad pod length. The historical ad pod start and end times correction sub-module 305 can then correct the ad pod start and end times using the historical data from the historical reference database 215.

The separation sub-module 310 of the watermark analysis module 210 separates the program portion 220 from the advertising portion 235 (“ad pods”). The program portion 220 can be spliced together after removing the advertising portion 235 and stored in the program database 225. The program portion 220 can later be called from the program database 225 by the program analysis module 230. The program analysis module 230 can determine the content of the program portion 220 and/or credits the program portion 220, as having been watched by the user. In some instances, the program portion 220 is identified by the watermark analysis module 210 due to the detected watermarks. The advertising portion 235 includes one or more ad pods such as the first ad pod 240 and the nth ad pod 245. Each ad pod is stored in the advertising database 250. The advertising portion 235 or a subset of the advertising portion 235 such as the first ad pod 240 can be called by the advertising analysis module 255. The advertising analysis module 255 determines the number of ad pods in the advertising portion 235, the number of ads in each ad pod, the length of each ad in each pod, the transitions within the advertising portion 235, the length of each ad pod, and/or the content of each ad. The advertising analysis module 255 credits the identified ads as having been viewed by the user. The advertising analysis module 255 can be used by the AME (implemented by one or more servers of the AME) to credit the identified ads.

In some aspects, the program analysis module 230 is omitted, and only the advertising portion 235 is analyzed.

In one or more aspects, the advertising analysis module 255 is omitted, and only the program portion 220 is analyzed.

In some instances, the program portion 220 of the video stream of media content 205 can be known prior to being ingested by the watermark analysis module 210 and/or determined by the watermark analysis module 210 by determining, for example, using metadata, the broadcaster of the program portion and/or the underlying media content. Using the information known about the program portion 220 allows the watermark analysis module 210 to pull the relevant historical reference information from the historical database 215. For example, the program portion 220 is identified as being broadcast on ABC®, and the historical database 215 has a template or typical start and end time for ad pods for a program on ABC®.

In several aspects, the watermark analysis module 210 or an alternative module determines a total length of the video stream of media content 205. The total length of the video stream of media content 205 can be used to pull relevant historical reference information from the historical database 215. For example, the total length of the video stream of media content 205 is determined to be an hour; and the watermark analysis module 210 calls only ad pod templates for media content that is an hour long from the historical database 215.

The illustration of the computing device 100 in FIG. 1 is not meant to imply physical or architectural limitations to the manner in which an example aspect can be implemented. Other components in addition to or in place of the ones illustrated can be used. Some components can be optional. Also, some blocks can be presented to illustrate functional components. One or more of the blocks in FIGS. 1, 2, and 3 can be combined, divided, or combined and divided into different blocks when implemented in an example aspect.

FIGS. 2-3 illustrate particular exemplary aspects of data flow of the computing device 100. It is understood that this exemplary division and relationship between the modules can be modified without departing from the scope or spirit of the present invention. For example, the depicted modules within the watermark analysis module 210 in FIG. 3 can be combined into larger modules. Additionally, functions described for the watermark analysis module 210 can be distributed across several modules.

### III. Example Operations

The computing device 100 and/or components thereof can be configured to perform and/or can perform one or more operations. Examples of these operations and related features will now be described.

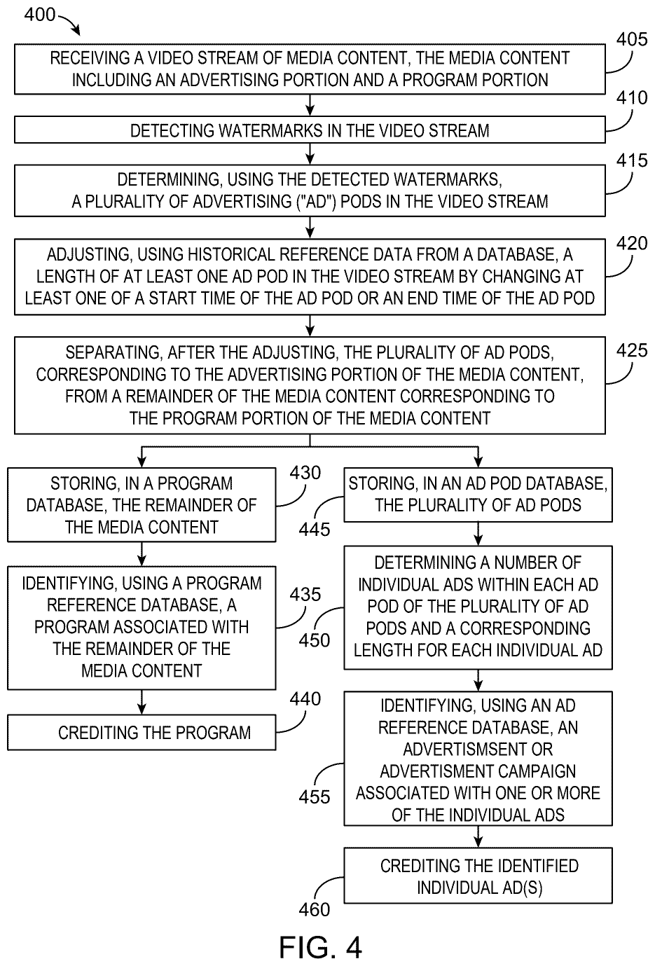

With reference to FIG. 4 and continuing reference to FIGS. 1-3, a method 400 for implementing the data flow 200 of the computing device 100 according to one or more embodiments. Method 400 is illustrated as a set of operations or blocks 405 through 460 and is described with continuing reference to FIGS. 1-3. Not all of the illustrated blocks 405 through 460 can be performed in all aspects of method 400. One or more blocks that are not expressly illustrated in FIG. 4 can be included before, after, in between, or as part of the blocks 405 through 460.

In some aspects, one or more of the blocks 405 through 460 can be implemented, at least in part, by the method 400, in the form of executable code stored on non-transitory, tangible, machine-readable media that when run by one or more processors can cause the one or more processors to perform one or more of the processes. The blocks in method 400 can be performed within the computing device 100 in FIG. 1 and/or to implement the data flow 200 of FIG. 2, as described herein.

In one or more aspects, the method 400 includes receiving a video stream of media content, the media content including an advertising portion and a program portion at a block 405; detecting watermarks in the video stream at a block 410; determining, using the detected watermarks, a plurality of advertising (“ad”) pods in the video stream at a block 415; adjusting, using historical reference data from a database, a length of at least one ad pod in the video steam by changing at least one of a start time of the ad pod or an end time of the ad pod at a block 420; separating, after the adjusting, the plurality of ad pods, corresponding to the advertising portion of the media content, from a remainder of the media content, corresponding to the program portion of the media content at a block 425; storing, in a program database, the remainder of the media content at a block 430; identifying using a program reference database, a program associated with the remainder of the media content at a block 435; and crediting the program at a block 440; storing, in an ad pod database, the plurality of ad pods at a block 445; determining a number of individual ads within each ad pod of the plurality of ad pods and a corresponding length for each individual ad at a block 450; identifying, using an ad reference database, an advertisement or advertisement campaign associated with one or more of the individual ads at a block 455; and crediting the identified individual ad(s) at a block 460.

In some aspects, at the block 405, the video stream of media content is the video stream of media content 205. The video stream of media content is received from a server, television, computer, or other console. The video stream can be replaced with an audio stream.

In one or more aspects, the block 405 is omitted. Instead, data associated with a number of watermarks and corresponding metadata (such as timestamps) are sent to the computing device 100.

In several aspects, the block 410 can include detecting watermarks that are embedded in the video stream. The block 410 can be implemented using a watermark decoder, the watermark analysis module 210, and/or the ad pod start and end times detection sub-module 300. For example, at the block 410, the ad pod start and end times detection sub-module 300 receives a video stream with embedded watermarks, decodes the embedded watermarks, and identifies source information and date and time information of a portion of the media content. The portion of the media content can correspond to the program portion and/or the advertising portion. The source information and date and time information, determined from the detected and decoded watermark, can be compared to program schedule information or a reference database to identify the media content and the particular program at the block 410. In other instances, the identification of the media content occurs using the program analysis module 230 at the block 435 using the information from the decoded watermarks.

In various aspects, the block 410 can include identifying, detecting, or determining commercial watermarks embedded in the video stream. The commercial watermarks, once decoded, identify ads with the video stream. The block 410 can detect watermarks for the program portion, commercial watermarks for the advertising portion, and/or both within the video stream of the media content.

In other instances, the block 410 can be omitted. The block 415 occurs after the block 405. The block 415 includes receiving the video stream with the watermarks already detected.

In one or more instances, the block 415 is implemented using the watermark analysis module 210 and/or the ad pod start and end times detection sub-module 300. The block 415 can include determining using the detected watermarks, only one ad pod. In other instances, the block 415 includes determining a plurality of ad pods throughout the video stream. The ad pods can be detected based on an amount of time between a first watermark and a second watermark. The block 415 or the block 410 includes determining one or more type(s) of watermark embedded in the video stream. Based on the type of watermark identified, the watermarks will be embedded in the program portion of the video stream in an expected pattern and/or time (such as every 1.6 seconds, 3.2 seconds, 4.8 seconds, 6.2 seconds, etc.). The watermark analysis module 210 can determine the type of watermark and the corresponding expected time between consecutive watermarks. For example, if the watermark embedded in the program portion is a watermark that is embedded every 4.8 seconds, then a gap between a first watermark and a second watermark having a time value of 15 seconds could be determined by the watermark analysis module 210 as an ad pod, such as the first ad pod 240.

In some aspects, the block 415 can include a threshold time value to determine that a gap in time between watermarks corresponds to a start and end time of an ad pod. The threshold value can be pre-determined and/or based on a type of watermark detected. The threshold value can be 2 seconds, 5 seconds, 10 seconds, 15 seconds, 30 seconds, 90 seconds, or the like. The block 415 can include determining an ad pod for when a gap between watermarks equals and/or exceeds the threshold value. The threshold can also be between a last detected watermark and the end of the video stream. For example, if a first watermark is detected at 1.6 seconds, and a second watermark is detected at 3.2 seconds, and a third watermark is detected at 9.6 seconds, an ad pod can be determined between the second and the third watermark. The watermark analysis module 210 can determine that the watermark type is one that is embedded every 1.6 seconds. This watermark type can have a threshold value of 2 seconds. In the example, over a six second gap between watermarks was determined which exceeds the threshold value, and an ad pod is determined.

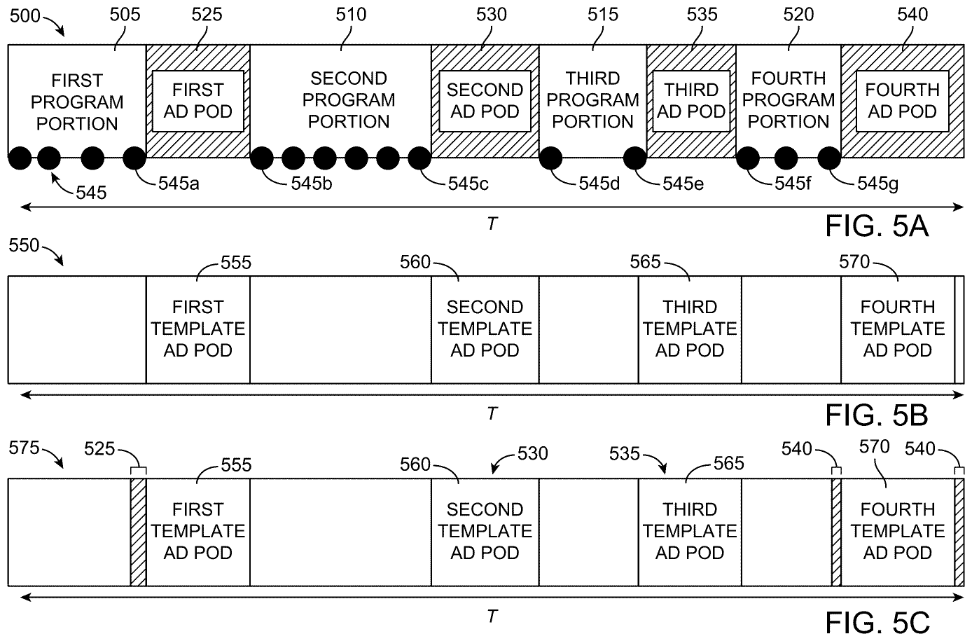

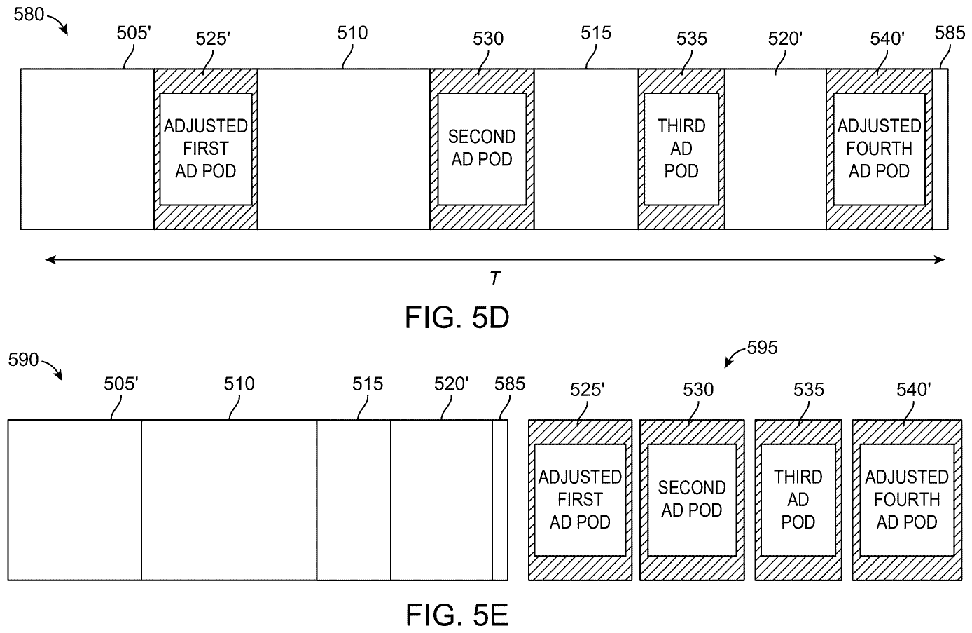

Referring to FIG. 5A, with continuing reference to FIG. 4, a video stream 500 is illustrated. The video stream 500 includes a plurality of program content portions (such as a first program portion 505, a second program portion 510, a third program portion 515, and a fourth program portion 520) interleaved with a plurality of ad pods (such as a first ad pod 525, a second ad pod 530, a third ad pod 535, and a fourth ad pod 540) extending over time (T). The video stream 500 includes a plurality of detected watermarks 545. The plurality of detected watermarks 545 includes a first watermark 545a and a second watermark 545b, which mark start and end time boundaries of the first ad pod 525. The plurality of detected watermarks 545 includes a third watermark 545c and a fourth watermark 545d, which mark start and end time boundaries of the second ad pod 530. The plurality of detected watermarks 545 includes a fifth watermark 545e and a sixth watermark 545f, which mark start and end time boundaries of the third ad pod 535. The plurality of detected watermarks 545 includes a seventh watermark 545g, which mark a start time boundary of the fourth ad pod 540, and the end of the video stream 500 marks the end time boundary of the fourth ad pod 540.

In some aspects, with continuing reference to FIG. 5A and FIG. 4, one or more watermarks such as commercial watermarks can be detected in the video stream 500 over T. The watermark analysis module 210 can be configured to distinguish between commercial watermarks and watermarks that identify program portions based on the data encoded by the watermarks and/or the manner in which the watermarks are encoded. The start and end time of the ad pods (such as the first ad pod) can be the timestamp and/or time associated with the first watermark 545a and the second watermark 545b, respectively. In the alternative, the block 415, using the watermark analysis module, can add or subtract time such as (1 second, 0.1 second, 0.001 second, or the like) from when the watermark detection to be the start and end time of the ad pod does not overlap with the watermark detection. For example, if the first watermark 545a is detected at time 19.2 seconds and the second watermark 545 b is detected at 52.8 seconds, then the first ad pod 525 is bound by the first watermark 545a and the second watermark 545b and could be determined by the watermark analysis module 210 to start at 19.3 seconds and end at 52.7 seconds. The watermark analysis module 210 could determine at the block 415 that the first ad pod 525 extends 33.4 seconds.

Returning to FIG. 4, in various instances, the block 415 includes determining a plurality of ad pods in the video stream using commercial watermarks instead of watermarks that identify the program portion. The commercial watermarks can be used to identify a start and end time of the ad pod. The first commercial watermark detected can be used to set a start time and the last commercial watermark detected can be used to set an end time of the ad pod. In other aspects, if a commercial watermark is detected, the commercial watermark can be used to adjust the start and end time of one or more ad pod(s) in the video stream.

In some aspects, at the block 415, the determining a plurality of ad pods in the video stream includes determining a start and end time of each ad pod in the video stream. The start and end times of each ad pod in the video stream can be output in a report. The time values associated with the start and end times of each ad pod in the video stream can be stored in a database for further analysis.

In one or more aspects, the block 415 includes transmitting metadata such as, but not limited to, the source information and/or the date and time information associated with the decoded watermarks from the ad pod start and end times detection sub-module 300 to the historical ad pod start and end times correction sub-module 305.

An additional block can be added, in several aspects, prior to the block 420, that identifies historical reference data related to the plurality of ad pods and/or the video stream of media content. For example, the block 420 can identify the network, program, program length, or the like and then retrieve historical reference data that corresponds to the metadata associated with the decoded watermarks such as but not limited to, the source information or the date and time information.

In some aspects, the block 420 includes retrieving, obtaining, and/or calling information from one or more databases. The one or more databases can include the historical database 215. The one or more databases can include historical reference data. The historical reference data can include information about a network's reference data for ad pods, a streaming service's reference data for ad pods, a specific program's reference data for ad pods, and the like. Reference data can include ad pod start and end times for a thirty-minute program, ad pod start and end times for an hour-long program, an ad pod start and end time for a program that is a movie, a number of ad pods, length(s) of ad pod(s), etc. The reference data can be values such as start and end times of ad pods over T, ad pod templates formed from historical values of ad pods, a graphical representation of ad pods, a numerical representation of start and end times of ad pods, etc. The historical reference data can be collected and input manually by a user. A model can be trained and generated using the historical reference data to determine the probable start and end times of ad pods for media content based on a network, streaming service, and/or program-specific. The block 415 can implement the trained model to adjust the start and end times of the ad pods.

In one or more aspects, the block 420 is implemented by the watermark analysis module 210 and/or the historical ad pod start and end times correction sub-module 305. The watermark analysis module 210 compares at the block 420 the historical reference data with the determined start and end times of the ad pod. For example, the historical reference data includes data related to programs on Amazon Prime Video® have historically had a first ad pod that is thirty seconds in length and the ad pods length that was determined using the detected watermarks in the block 415 has a length of 32 seconds. The watermark analysis module 210 can compare the two lengths and/or start and end times to determine that the detected watermark is two seconds longer than the historical ad pod length. The watermark analysis module 210 can weight the historical ad pod length greater than the detected watermark ad pod length. The watermark analysis module 210 can adjust the detected watermark ad pod length by shortening it to the historical ad pod length. The watermark analysis module 210 at the block 420 can adjust the start and/or end times of the ad pod based on the adjusted length.

In some aspects, the block 420 includes adjusting the start and end times of one or more ad pod(s) over T. The start and end times of the one or more ad pods can be compared to expected start and end times stored in the database such as the historical database 215. The block 420 can determine if the start and end times of the one or more ad pods are within an acceptable variance from the expected start and end times stored in the database. If the start and end times of the one or more ad pods are within the acceptable variance, then the start and end times of the one or more ad pods are adjusted to match the expected start and end times stored in the historical database. If the start and end times of the one or more ad pods are not within the acceptable variance, then the start and end times of the one or more are not adjusted. If the start and end times of the one or more ad pods match the expected start and end times stored in the historical database, then the start and end times of the one or more ad pod(s) are not adjusted and the block 420 is omitted.

Referring to FIG. 5B, with continuing reference to FIG. 4 and FIG. 5A, in one aspect, historical reference data 550 is illustrated. The historical reference data 550 could be stored in historical database 215. The historical reference data 550 could be used by the block 415 of FIG. 4 to adjust the start and end times of the ad pods. FIG. 5B illustrates one example of historical reference data. The historical reference data 550 is a template that includes a plurality of ad pods having start and end times over T. The historical reference data 550 includes a first template ad pod 555, a second template ad pod 560, a third template ad pod 565, and a fourth template ad pod 570.

In some aspects, the historical reference data 550 is represented and/or implemented numerically rather than graphically. For example, the first template ad pod 555 could be stored in a database as “first template ad pod 555, start time: 4.12 seconds, end time: 34.12 seconds”.

Referring now to FIG. 5C, with continuing reference to FIGS. 4-5B, a comparison of the video stream 500 and the historical reference data 550 is generally referred to by reference numeral 575. The comparison 575 overlaps the first ad pod 525 with the first template ad pod 555, the second ad pod 530 with the second template ad pod 560, the third ad pod 535 with the third template ad pod 565, and the fourth ad pod 540 with the fourth template ad pod 570. The block 420 is omitted for the second ad pod 530 and the third ad pod 535. The start and end times and/or length of the second ad pod 530 matches the start and end times and/or length of the second template ad pod 560. The start and end times and/or length of the third ad pod 535 matches the start and end times and/or length of the third template ad pod 565. The first ad pod 525 is longer than the first template ad pod 555. The first ad pod 525 has an earlier start time than the first template ad pod 555. The first ad pod 525 and the first template ad pod 555 have the same end time. With reference again to FIG. 4, the block 420 adjusts the first ad pod 525 to match the first template ad pod 555, as described herein. The first ad pod 525 can have more program portion content that occurred after the first watermark 545a and before the first ad pod 525 began. Referring back to FIG. 5C, the fourth ad pod 540 has a different start and end time in comparison to the fourth template ad pod 570. The fourth ad pod 540 has a greater length than the length of the fourth template ad pod 570. With reference again to FIG. 4, the block 420 adjusts the start and end time of the fourth ad pod 540 to match the start and end time of the fourth template ad pod 570. Referring back to FIG. 5C, the fourth ad pod 540 can have more program portion content that occurred after the seventh watermark 545g and more program portion content after the fourth ad pod 540 that was not detected by a watermark before the video stream 500 ended.

Returning back to FIG. 4, the block 420, in some instances, can overlay and/or compare the start and end times of ad pods within a video stream (such as video stream 500) with historical reference data (such as the historical reference data 550). In some aspects, this comparison, such as the comparison 575, is represented and/or implemented numerically rather than graphically.

In some aspects, the block 420 includes generating one or more adjusted ad pod(s). For example, referring to FIG. 5D, with continuing reference to FIGS. 4-5C, an adjusted video stream 580 is illustrated. The adjusted video stream 580 is the video stream 500 adjusted with the historical reference data 550 from the comparison 575. The adjusted video stream 580 includes an adjusted first program portion 505′, an adjusted first ad pod 525′, the second program portion 510, the second ad pod 530, the third program portion 515, the third ad pod 535, an adjusted fourth program portion 520′, an adjusted fourth ad pod 540′, and a fifth program portion 585. In comparison to the video stream 500, the adjusted first program portion 505′ is greater in length than the first program portion 505 since the first ad pod 525 had an earlier start time than the adjusted first ad pod 525′. The adjusted first ad pod 525′ is shorter in length than the first ad pod 525. The adjusted fourth program portion 520′ is greater in length than the fourth program portion 520 because the fourth ad pod 540 had an earlier start time than the adjusted fourth ad pod 540′. The adjusted fourth ad pod 540′ is shorter in length than the fourth ad pod 540. The fourth ad pod 540 extended to the end of the video stream 500. The adjusted fourth ad pod 540′ had an end time prior to the end of the adjusted video stream 580, and the fifth program portion 585 extends to the end of the adjusted video stream 580. Both the video stream 500 and the adjusted video stream 580 extend over the same time, time T. The adjusted video stream 580 can be generated by the watermark analysis module 210 and/or the historical ad pod start and end times correction sub-module 305 and implemented at the block 420 of FIG. 4.

Referring again to FIG. 4, in some aspects, the block 420 outputs one or more adjusted ad pods, one or more adjusted video streams (such as the adjusted fourth program portion 520′), start and end times of all ad pods, including one or more adjusted start and end times of ad pod(s), start and end times of program content portions, metadata associated with the decoded watermarks, and the like. The output can be a report, graph, chart, or other visual representation. The output can be sent to a computing system or server like the computing device 100 or to the separation sub-module 310.

The block 425, in some instances, separates the ad pods in the video stream from the remainder of the video stream. The block 425 can separate one ad pod from the video stream or a plurality of ad pods. The block 425 can be implemented using the watermark analysis module 210 and/or the separation sub-module 310.

For example, referring to FIG. 5E, with continuing reference to FIGS. 4-5C, the program portion (also referred to herein as “the remainder”) is generally referred to by reference numeral 590, and the advertising portion (also referred to herein as the “ad pods”) is generally referred to by reference numeral 595. The program portion 590 includes the adjusted first program portion 505′, the second program portion 510, the third program portion 515, the adjusted fourth program portion 520′, and the fifth program portion 585. The adjusted first program portion 505′, the second program portion 510, the third program portion 515, the adjusted fourth program portion 520′, and the fifth program portion 585 can be spliced together to form the program portion 590, forming program content such as a television show without the ads. In other instances, the adjusted first program portion 505′, the second program portion 510, the third program portion 515, the adjusted fourth program portion 520′, and the fifth program portion 585 are separated from the advertising portion 595 and not spliced together. The advertising portion 595 includes the adjusted first ad pod 525′, the second ad pod 530, the third ad pod 535, and the adjusted fourth ad pod 540′. In several instances, the program portion 590 can be the program portion 220. The advertising portion 595 can be the advertising portion 235.

Returning to FIG. 4, in one or more aspects, the block 425 separates the remainder from the ad pods. The block 425 can splice together the remainder to form the program portion or splice together all the ad pods to form an advertising portion. In other instances, the block 425 does not splice together the remainder to form the program portion or splice all the ad pods to form the advertising portion.

In several instances, the block 430 includes storing a single file of the remainder of the media content (such as the spliced together program portion 590) in a database such as the program database 225. In other instances, the block 430 stores the individual program portions (such as the adjusted first program portion 505′, the second program portion 510, etc. shown in FIG. 5E). The block 430 can store the remainder of the media content as well as information associated with identification of the remainder (e.g., source identification information, date and time information, etc.).

In one or more aspects, the block 435 can use a module such as the program analysis module 230 to identify the program associated with the remainder of the media content. At the block 435, the remainder of the media content can be used to generate a signature to compare to one or more reference signatures stored in the program reference database. In some instances, the reference signatures can be generated using the entire video stream. When the signature matches one of the reference signatures stored in the program reference database, the program associated with the remainder of the media content can be identified. At the block 435, the remainder of the media content can contain one or more watermarks, as described herein, that can be decoded to determine the program associated with the remainder of the media content. The program analysis module 230 or the watermark analysis module 210 can include a watermark decoder to decode the one or more watermarks in the remainder of the media content and the program reference database stores watermark information to identify the remainder of the media content.

In some aspects, the block 435 is omitted.

In one or more aspects, an additional block occurs in the method 400. The video stream includes one or more watermarks that are decoded to determine the program associated with the media content. The watermark analysis module 210 and/or the program analysis module 230 can include a watermark decoder to decode the one or more watermarks and comparing the decoded watermark to stored watermark information in a watermark database. The decoded watermark can include information such as timestamps, broadcaster information, network information, streaming platform information, media identification information, and the like. The information from the decoded watermark can be used to filter information from the historical database at the block 420.

In some instances, the block 440 is omitted. The block 435, instead proceeds, to storing data associated with the remainder of the media content to identify future media content. For example, a watermark could be used to identify the program associated with the remainder of the media content, and then the additional block could generate a signature from the remainder of the media content and store that signature of the remainder with the information from the watermark to identify the media content in the future when a watermark is not available.

The block 440, in one or more aspects, includes crediting the identified program as having been viewed and/or presented to the user. The block 440 can include generating a report, outputting impression data associated with the program, and the like.

One or more of the blocks 430-440, in some aspects, can be omitted. One or more blocks of 430-440 can occur before, simultaneously with, or after blocks 445-460.

In some aspects, at the block 445, the advertising portion 595 can be stored in an ad pod database (such as the advertising database 250). In other instances, the individual ad pods of the advertising portion (such as the adjusted first ad pod 525′, the second ad pod 530, the third ad pod 535, and the adjusted fourth ad pod 540′) are stored in the database, such as the advertising database 250. In yet another aspect, the block 445 includes identifying the individual ads within each ad pod of the plurality of ad pods and storing the individual ads separately. The block 445, in some aspects, stores only a single ad pod, and in other aspects, stores a plurality of ad pods. The block 445 can store the plurality of the ad pods as well as information associated with identification of one or more of the advertisements within the plurality of ad pods (e.g., source identification information, date and time information, etc.).

The block 450, in one or more aspects, can be implemented by the advertising analysis module 255. The block 450 can determine a length for each ad, a start time for each ad, and/or an end time for each ad. The block 450 can detect transitions (such as a fade to black) in the ad pod(s) to determine individual ads within an ad pod.

In some instances, the block 455 occurs after the block 450. The block 455 can be implemented using the advertising analysis module 255. The block 455 can include generating a signature for one or more ad(s) within the ad pod. The block 455 can include comparing the signature to reference signatures stored in the ad reference database. The block 455 can include comparing a commercial watermark embedded in the individual ad to known information corresponding to the commercial watermark stored in the ad reference database. The block 455 can include decoding a commercial watermark. The block 455 can include matching one or more characteristics (such as color, shape, font, and etc.) to one or more known characteristics stored in the ad reference database. The block 455 can include identifying the ad, the product being sold, a particular ad campaign, or the like.

In several instances, an additional block can be included after the block 455. The additional block can remove an ad stored in the ad pod database after the ad has been identified. The additional block can update the ad pod database to include a timestamp for when the last attempt to identify the ad occurred. The additional block can send the ad that has yet to be identified back to the block 455 when an event occurs (such as the ad reference database has been updated to include new ad references) or a time threshold has been met (one week since identification was attempted. The additional block can remove an ad stored in the ad pod database after a period of time (e.g., one month, six months, and the like), even if no identification occurred. The additional block can also send the ad for manual review to a user so that the user can identify the ad. When the ad is identified, the ad can be stored in the ad reference database so that future airings of the ad can be identified using the block 455.

In some aspects, after the block 455, the block 460 occurs. The ads that have been identified can be credited. The block 460 can include generating a report, outputting a number of impressions of the ad, outputting the demographics of who viewed the ad, and the like.

In various aspects, one or more of the blocks 450-460 are omitted.

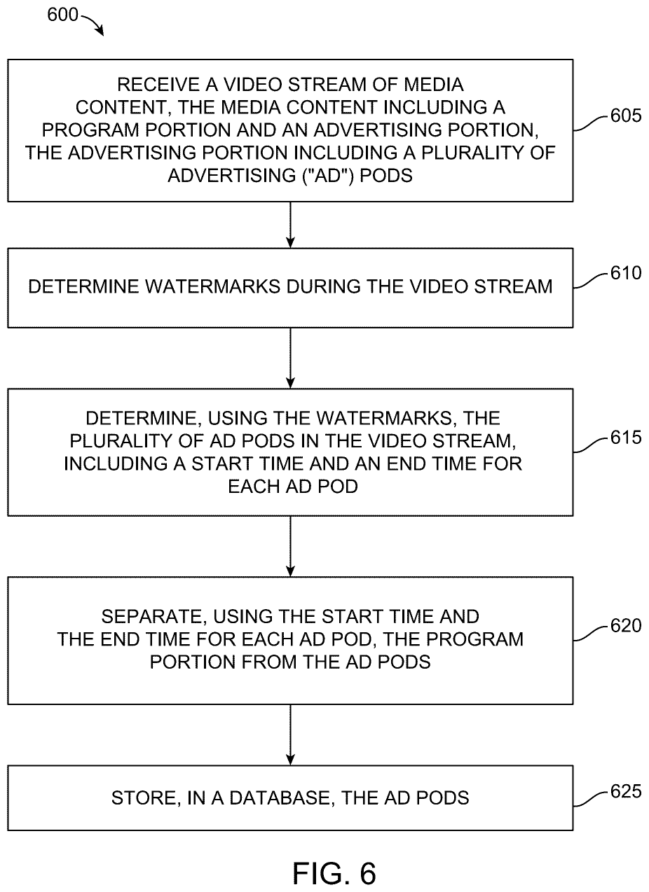

With reference to FIG. 6 and continuing reference to FIGS. 1-3, a method 600 for implementing the data flow 200 of the computing device 100 according to one or more embodiments. Method 600 is illustrated as a set of operations or blocks 605 through 625 and is described with continuing reference to FIGS. 1-3. Not all of the illustrated blocks 605 through 625 can be performed in all aspects of method 600. One or more blocks that are not expressly illustrated in FIG. 6 can be included before, after, in between, or as part of the blocks 605 through 625.

In some aspects, one or more of the blocks 605 through 625 can be implemented, at least in part, by the method 600, in the form of executable code stored on non-transitory, tangible, machine-readable media that when run by one or more processors can cause the one or more processors to perform one or more of the processes. The blocks in method 600 can be performed within the computing device 100 in FIG. 1 and/or to implement the data flow 200 of FIG. 2, as described herein.

In one or more aspects, the method 600 includes receiving a video stream of media content, the media content including a program portion and an advertising portion, the advertising portion including a plurality of advertising (“ad”) pods at a block 605; determine watermarks during the video stream at a block 610; determining, using the watermarks, the plurality of ad pods in the video stream, including a start and an end time for each ad pod at a block 615; separating, using the start time and the end time for each ad pod, the program portion from the ad pods at a block 620; and storing, in a database, the ad pods at a block 625.

In some aspects, at the block 605, the video stream is replaced with an audio stream. The video stream can be a video stream for a television show including commercial breaks, referred to herein as ad pods, a movie including ad pods, a video game including ad pods, and the like. The video stream can include a program portion and an advertising portion. The program portion can include a plurality of program sub-portions interleaved with a plurality of advertising sub-portions, referred to herein as ad pods. The video stream can include only a single ad pod. Each ad pod can include one or more advertisements. The one or more ad pods can vary in the number of ads within each ad pod, the length of ads within each ad pod, and vary in the length of the overall ad pod. The video stream can include a plurality of programs such as a first television show followed by a second television show. The video stream can be received via the computing device 100.

In one or more instances, the block 610 occurs after the block 605. The additional block detects watermarks that are embedded in the video stream. The watermarks can be detected using the watermark analysis module 210. The detection can include detecting a presence of a watermark and a corresponding timestamp for when the watermark was detected during the video stream. The watermark can later be decoded.

In several aspects, the block 610 generates watermark information in the form of a chart, dataset, diagram, or other graphical representation. The watermark information includes each watermark detection and corresponding timestamp associated with the watermark detection for all watermarks within the video stream. The generated information can be automatically created and/or updated after each detection of a watermark and corresponding timestamp. This generated information can be used by the block 615.

In some instances, the block 610 detects and decodes the watermarks in the video stream. The watermarks can be detected and decoded using a watermark decoder. The watermark decoder can be in the watermark analysis module 210. The watermark decoder can decode the watermark information about the program portion of the video stream—such as the network, program identification information, a timestamp, and the like. The watermark decoder can decode commercial watermark information about the advertising portion of the video stream—such as advertising identification information, brand information, a timestamp, and the like. At this block, other metadata can be detected and used to identify information about the video stream. The other metadata and information from the decoded watermarks can be added to watermark information, such as adding the other metadata and the information from the decoded watermarks in the chart corresponding to this video stream.

In several aspects, the block 615 occurs after the block 610. The block 615 uses the watermark information such as the detected watermarks and the corresponding timestamp to determine the plurality of ad pods in the video stream. The video stream can have one or more ad pods. The block 615 can be implemented by the watermark analysis module 210.

In one or more aspects, the block 615 uses a threshold amount of time to determine if an ad pod is detected. For example, if a first watermark is detected at 10.62 seconds, a second watermark is detected at 13.82 seconds, and a third watermark is detected at 45.82, the block 615 can compare the length of time between each watermark to a threshold value (such as five seconds, ten seconds, 12.8 seconds, and the like) and determine that an ad pod occurred between the second watermark and the third watermark.

In some instances, the threshold amount is predetermined and stored in the watermark analysis module 210. The predetermined threshold amount can be based on the most common watermarks and the time that each of these watermarks are embedded in a video stream. For example, if the three most common watermarks are embedded every 1.8, 3.2, and 4.8 seconds, then the predetermined threshold amount could correspond to a gap between two consecutive watermarks that is greater than 4.8 seconds such as 4.9 seconds, 5 seconds, and the like. Alternatively, and/or additionally, the predetermined threshold can be based on the known ad pod times such as 6 seconds, 15 seconds, 30 seconds, 60 seconds, or 90 seconds. The threshold amount could correspond to a gap between two consecutive watermarks that corresponds to the typical ad pod times. For example, a gap between two consecutive watermarks that equals or exceeds 6 seconds indicates an ad pod.

In one or more instances, the threshold amount is stored in the historical database such as the historical database 215. The watermark analysis module 210 can call the historical database to transmit a threshold amount to the watermark analysis module 210 based on the video stream of media content such as the video stream of media content 205. The threshold amount can be based on a particular network, broadcaster, streaming service, and the like.

In other instances, at the block 615, the threshold amount of time between two consecutive watermarks to identify that gap in time as an ad pod is determined. The watermark analysis module 210 determines a threshold based on the video stream such as the video stream of media content 205. The watermark analysis module 210 can detect that the watermark for the program portion is repeating every 3.2 seconds and determine that the threshold amount of time to be considered an ad pod is a time greater than 3.2 seconds between two consecutive watermarks.

In various instances, the block 615 determines a start and end time for each ad pod in the video stream of media content. The start and the end times of each ad pod can be detected using the ad pod start and end times detection sub-module 300 of the watermark analysis module 210. The start and end times detection sub-module 300 can identify and/or detect the watermarks embedded in the video stream. Using the identified and/or detected watermarks, the start and end times detection sub-module 300 can determine the start and end times of the ad pods. The start time and the end time of an ad pod of the ad pods corresponds to time immediately after a first watermark and a time immediately before a second, consecutive watermark, respectively, that has a sufficient time gap between the first and the second watermarks to be identified as an ad pod. The sufficient gap could be the threshold amount described herein. The start time can be the second after, the 0.1 second after, or the 0.01 second after a timestamp associated with the first watermark. The end time can be the second before, the 0.1 second before, or the 0.01 second before a timestamp associated with the second watermark. For example, in some instances, at the block 615, if a third watermark is detected at 14.6 seconds and a fourth watermark is detected at 106.6 seconds, then the start time of the ad pod can be determined by the watermark analysis module 210 as 15.6 seconds and the end time could be determined by the watermark analysis module 210 as 105.6. The length of the ad pod could be determined as 90 seconds in length. The block 615 can determine the start and end time for each ad pod of the plurality of ad pods.

In some instances, the block 615 can determine the length of the ad pod, which is the amount of time between the start time and the end time for the ad pod. The block 615 can store the start time, the end time, and/or the length in a database.

In various aspects, at the block 615, the historical ad pod start and end times correction sub-module 305 is bypassed and after the ad pod start and end times detection sub-module 300 outputs the start and end times of each ad pod, the separation sub-module 310 is instead run and the block 620 occurs. In other instances, the historical ad pod start and end times correction sub-module 305 is implemented during block 615. The historical ad pod start and end times correction sub-module 305 uses data stored in the historical database 215 to adjust the start and/or the end time of one or more ad pods of the ad pods, as described herein.

After the block 615, in several instances, the block 620 occurs. The block 620 uses the start time and end times for each ad pod to identify the ad pods from the program portion. The block 620 separates the ad pods from the program portion. The block 620 can use the watermark analysis module 210 and/or the separation sub-module 310 of the watermark analysis module 210. The block 615 can separate the portions of the video stream that correspond to the ad pods (such as the advertising portion 235 or a portion of the advertising portion 235 including the first ad pod 240) from the program portion such as the program portion 220. The block 620 cuts the video stream based on the start and end times identified in the block 615.

After the block 620, in several aspects, the ad pods are stored in a database such as the advertising database 250 at the block 625. The ad pods can be a single ad pod or a plurality of ad pods. Each ad pod can be stored separately in the advertising database or can be stored together as the advertising portion from the respective video stream.

In some instances, an additional block occurs after the block 620 or the block 625. The additional block can store the program portion separated in the database or a separate database such as the program database 225.

In one or more instances, an additional block occurs after the block 620 or the block 625. The additional block can delete, remove, or otherwise not save the program portion of the video stream

In various aspects, an additional block occurs after the block 625. The additional block can process one or more ad pods to identify length of the ad pod, a number of ads within the ad pod, the length of the individual ads in the ad pod, identify ad identifying information, credit ads as having been viewed, and the like. The additional block can be implemented using the advertising analysis module 255.

In other aspects, the method 600 ends at the block 625.

### IV. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

What is claimed is:

1. A method comprising:
obtaining a video stream of media content,
wherein the media content comprises an advertising portion and a program portion, and
wherein the advertising portion comprises a plurality of advertising pods interleaved with the program portion;
detecting watermarks embedded in the video stream;
determining, using the detected watermarks, the plurality of advertising pods in the video stream;
adjusting, using reference data from a database, a length of at least one advertising pod of the plurality of advertising pods in the video stream; and
separating, after the adjusting, the program portion from the advertising pods in the video stream.

2. The method of claim 1, further comprising:
outputting the adjusted length of the at least one advertising pod.

3. The method of claim 1, wherein the reference data from the database comprises historical reference data related to lengths of advertising pods.

4. The method of claim 1, further comprising:
identifying a network or a streaming service associated with the video stream, and
wherein the reference data corresponds to historical reference data related to lengths of advertising pods for the network or the streaming service.

5. The method of claim 1, further comprising:
storing, in another database, the separated advertising pods.

6. The method of claim 1, wherein the adjusting, using the reference data from the database, the length of the at least one advertising pod comprises adjusting at least one of a start time or an end time of the at least one advertising pod.

7. The method of claim 6, further comprising:
outputting, after the adjusting, start and end times of each advertising pod of the advertising pods.

8. The method of claim 1, further comprising:
storing the separated advertising pods.

9. A non-transitory computer-readable storage medium, having stored thereon program instructions that, upon execution by a processor, cause performance of a set of operations comprising:
obtaining a video stream of media content with a plurality of watermarks embedded in the video stream,
wherein the media content comprises an advertising portion and a program portion, and
wherein the advertising portion comprises a plurality of advertising pods interleaved with the program portion;
determining, using the watermarks, the plurality of advertising pods in the video stream;
adjusting, using reference data from a database, at least one of a start time or an end time of an advertising pod of the plurality of advertising pods in the video stream; and
separating, after the adjusting, the program portion from the advertising pods in the video stream.

10. The non-transitory computer-readable storage medium of claim 9, the set of operations further comprising:
detecting the watermarks embedded in the video stream.

11. The non-transitory computer-readable storage medium of claim 9, wherein the reference data from the database comprises historical reference data related to start and end times of advertising pods.

12. The non-transitory computer-readable storage medium of claim 9, the set of operations further comprising:
identifying a network or a streaming service associated with the video stream, and
wherein the reference data corresponds to historical reference data related to start and end times of advertising pods for the network or the streaming service.

13. The non-transitory computer-readable storage medium of claim 9, the set of operations further comprising:
identifying content associated with the program portion of the video stream, and
wherein the reference data corresponds to historical reference data related to start and end times of advertising pods for the content.

14. The non-transitory computer-readable storage medium of claim 9, the set of operations further comprising:
storing, in another database, the separated advertising pods.

15. The non-transitory computer-readable storage medium of claim 14, the set of operations further comprising:
identifying, from the separated advertising pods, content of at least one advertisement.

16. A computing system comprising:
a processor; and
a non-transitory computer-readable storage medium, having stored thereon program instructions that, upon execution by the processor, cause performance of a set of operations comprising:
obtaining a video stream of media content,
wherein the media content comprises an advertising portion and a program portion, and
wherein the advertising portion comprises a plurality of advertising pods interleaved with the program portion;
detecting watermarks embedded in the video stream;
determining, using the detected watermarks, the plurality of advertising pods in the video stream;
adjusting, using reference data from a database, at least one of a start time or an end time of an advertising pod of the plurality of advertising pods in the video stream; and
separating, after the adjusting, the program portion from the advertising pods in the video stream.

17. The computing system of claim 16, the set of operations further comprising:
identifying a network or a streaming service associated with the video stream, and
wherein the reference data corresponds to historical reference data related to start and end times of advertising pods for the network or the streaming service.

18. The computing system of claim 16, the set of operations further comprising:
identifying content associated with the program portion of the video stream, and
wherein the reference data corresponds to historical reference data related to start and end times of advertising pods for the content.

19. The computing system of claim 18, the set of operations further comprising:
storing, in another database, the separated advertising pods.

20. The computing system of claim 19, the set of operations further comprising:
identifying, from the separated advertising pods, content of at least one advertisement.
